(19) United States
(12) Patent Application Publication
(10) Pub. No.: US 2012/0285633 A1
(43) Pub. Date: Nov. 15, 2012

(54) Sun shield assembly

(75) Inventor: Paul Lin, Tainan City (TW)

(73) Assignee: MACAUTO INDUSTRIAL CO., LTD.

(21) Appl. No.: 13/068,336

(22) Filed: May 9, 2011

(51) Int. Cl. E06B 9/56; E06B 9/44

(52) U.S. Cl. 160/293.1; 160/323.1

(57) ABSTRACT

A sun shield assembly includes: a spool housing provided with first and second supporting seats; a spool-supporting unit disposed in the spool housing and having first and second studs opposite to each other in an axial direction and coupled to the first and second supporting seats, respectively; a spool mounted rotatably to the spool-supporting unit; and a sun shield member mounted movably on the spool. The first supporting seat includes a casing, and a coupler disposed in the casing and formed with an insert hole. The first and second studs extend into the insert hole in the coupler and the first supporting seat, respectively. The first supporting seat further includes an urging member mounted in the casing to urge resiliently the coupler in a first radial direction relative to the axial direction.

### BACKGROUND OF THE INVENTION

1. Field of the Invention

This invention relates to a sun shield assembly, more particularly to a sun shield assembly including a shaft with one end coupled to a spring-biased coupler that is movably mounted to a supporting seat.

2. Description of the Related Art

A conventional sun shield assembly for use in a car includes: a spool housing defining an accommodating space and provided with two supporting seats at two ends thereof; a shaft disposed in the accommodating space and having two studs fixed to the supporting seats, respectively; a spool mounted rotatably on the shaft; and a sun shield member mounted on the spool such that the sun shield member can be wound on or unwound from the spool, and having a free end provided with an engaging means. The sun shield member is suitable for covering a sunroof that is formed in the roof of the car. The roof of the car is provided with two fixed seats at one side of the sunroof for installation of the conventional sun shield assembly through engagement between the supporting seats and the fixed seats, respectively, and a holder at an opposite side of the sunroof for engaging the engaging means on the sun shield member.

Due to errors in manufacturing the parts of the conventional sun shield assembly, as well as installation errors, the fixed seats installed on the roof of the car may not be aligned along a desired centerline (A), e.g., one of the fixed seats will lie on the centerline (A), while the other of the fixed seats will deviate from the centerline by 3-5 mm. As a consequence, the distance between one of the studs and the holder will differ from that between the other of the studs and the holder. Hence, when the sun shield member is unwound from the spool and the engaging means on the sun shield member engages the holder, undesired folding will occur at one side of the sun shield member.

### SUMMARY OF THE INVENTION

Therefore, an object of the present invention is to provide a sun shield assembly that can overcome the aforesaid drawback associated with the prior art.

According to the present invention, there is provided a sun shield assembly. The sun shield assembly comprises: a spool housing provided with first and second supporting seats and defining an accommodating space between the first and second supporting seats; a spool-supporting unit disposed in the accommodating space and having first and second studs that are opposite to each other in an axial direction and that are coupled to the first and second supporting seats, respectively; a spool mounted rotatably to the spool-supporting unit; and a sun shield member wound on the spool and extendable from the spool when unwound from the spool. The first supporting seat includes a casing defining an inner space, a coupler disposed in the inner space and formed with an insert hole, and an urging member mounted in the inner space to urge resiliently the coupler in a first radial direction relative to the axial direction. The first and second studs extend into the insert hole in the coupler of the first supporting seat and the second supporting seat, respectively. The coupler of the first supporting seat is movable relative to the casing of the first supporting seat in the first radial direction against the urging action of the urging member.

### BRIEF DESCRIPTION OF THE DRAWINGS

In drawings which illustrate the preferred embodiments of the invention,

FIG. 1 is a perspective view of the preferred embodiment of a sun shield assembly according to the present invention;

FIG. 2 is a fragmentary, exploded perspective view of the preferred embodiment;

FIG. 3 is an assembled perspective view of a supporting seat of the preferred embodiment, viewed from one side thereof;

FIG. 4 is an assembled perspective view of the supporting seat of the preferred embodiment, viewed from the side illustrated in FIG. 3 but at a different angle;

FIG. 5 is an exploded perspective view of the supporting seat of the preferred embodiment;

FIG. 6 is an assembled perspective view of the supporting seat of the preferred embodiment, viewed from a side thereof opposite that from which the supporting seat is viewed in FIG. 3;

FIG. 7 is an exploded perspective view of the supporting seat of the preferred embodiment, viewed from the side illustrated in FIG. 6 but at a different angle;

FIG. 8 is a schematic view illustrating a state where a sun shield member of the preferred embodiment is partially extended from a spool; and

FIG. 9 is a schematic view illustrating another state where the sun shield member of the preferred embodiment is entirely extended from the spool.

### DETAILED DESCRIPTION OF THE PREFERRED EMBODIMENT

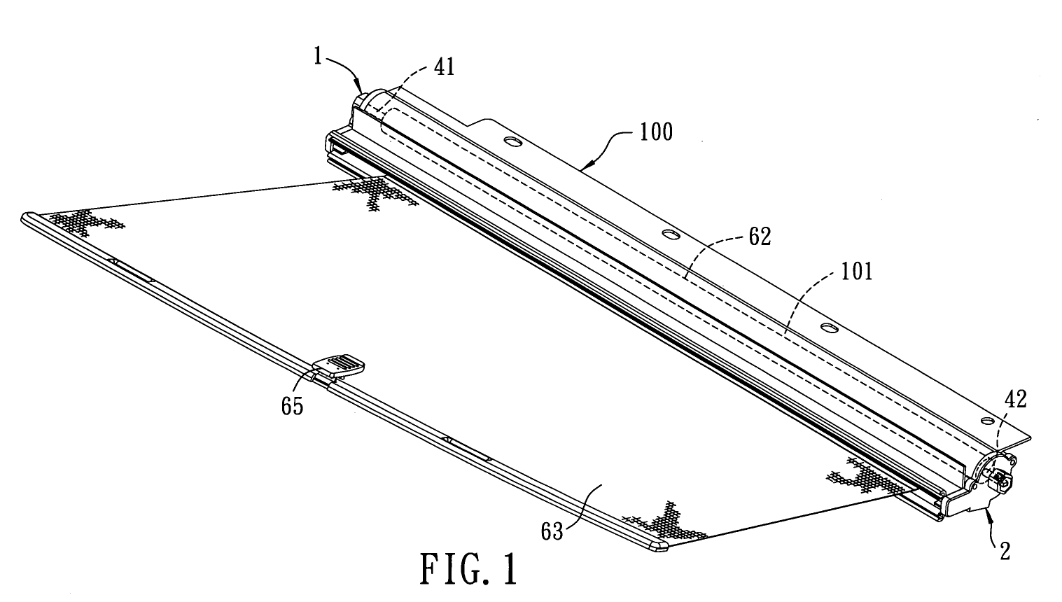

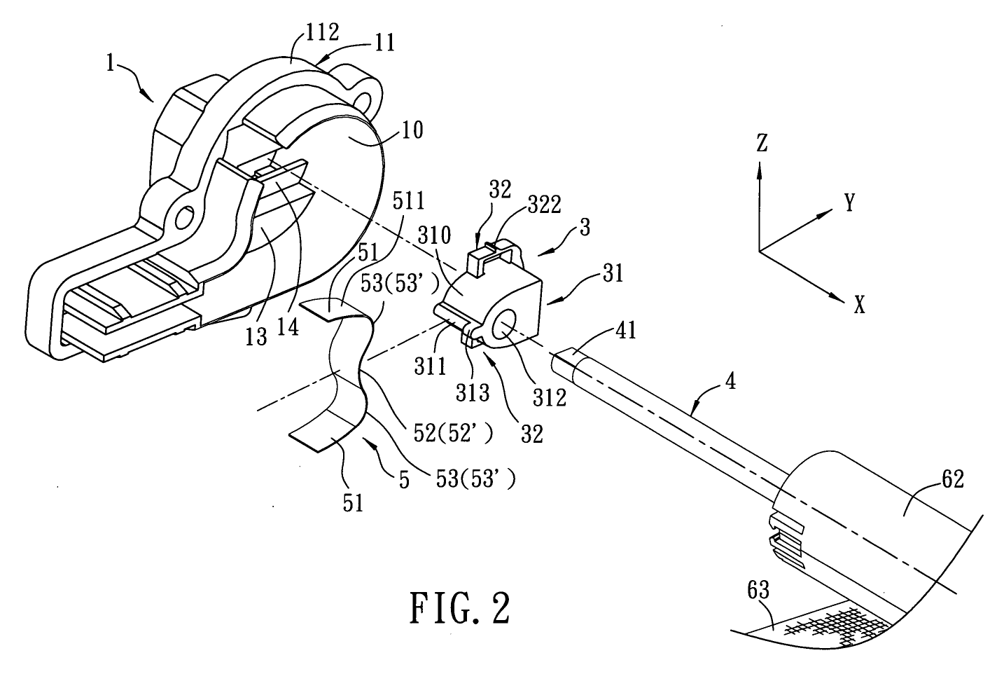

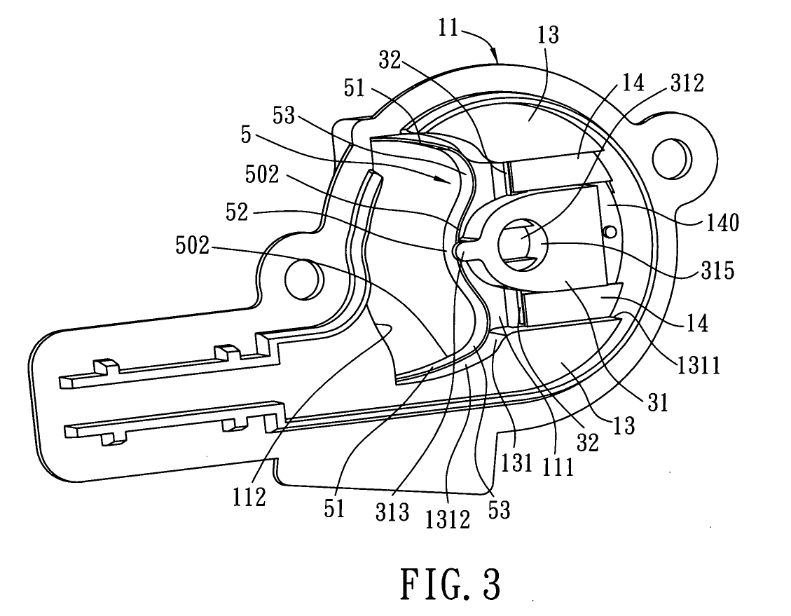

FIGS. 1 to 7 illustrate the preferred embodiment of a sun shield assembly according to the present invention. The sun shield assembly includes: a spool housing 100 provided with first and second supporting seats 1, 2 and defining an accommodating space 101 between the first and second supporting seats 1,2; a spool-supporting unit 4 disposed in the accommodating space 101 and having first and second studs 41, 42 that are opposite to each other in an axial direction (X) and that are coupled to the first and second supporting seats 1, 2, respectively, the spool-supporting unit 4 being in the form of a shaft having two opposite ends defining the first and second studs 41, 42, respectively; a spool 62 mounted rotatably to the spool-supporting unit 4; and a sun shield member 63 wound on the spool 62, extendable from the spool 62 when unwound from the spool 62, and provided with an engaging means 65 at a free end thereof. The first supporting seat 1 includes a casing 11 defining an inner space 10, a coupler 3 disposed in the inner space 10 and formed with an insert hole 312 which is defined by a hole-defining wall 315 (see FIG. 3), and an urging member 5 mounted in the inner space 10 to urge resiliently the coupler 3 in a first radial direction (Y) relative to the axial direction (X). The first and second studs 41, 42 extend into the insert hole 312 in the coupler 3 of the first supporting seat 1 and an insert hole (not shown) in the second supporting seat 2, respectively. The coupler 3 of the first supporting seat 1 is movable relative to the casing 11 of the first supporting seat 1 in the first radial direction (Y) against the urging action of the urging member 5 when applied by an external force resulting from pulling action of the shun shield member 63 out of the accommodating space 101.

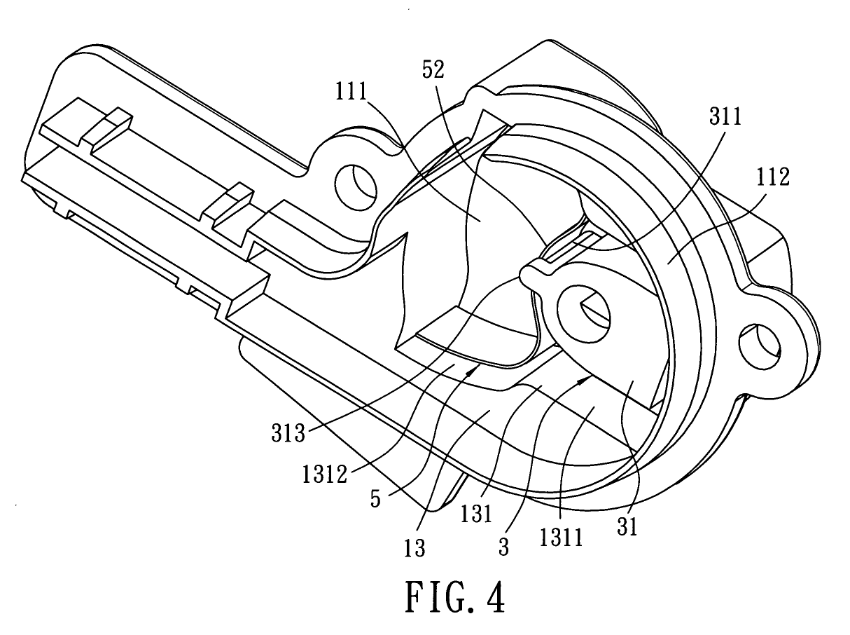

The urging member 5 is in the form of a curved resilient plate 5 that has two opposite end segments 51 and a curved middle segment 52 extending between the end segments 51 of the resilient plate 5. The end segments 51 of the resilient plate 5 abut against the casing 11. The coupler 3 includes a main body 31 that is formed with the insert hole 312, that has a front end 310, and that is formed with a nose 311 protruding from the front end 310 of the main body 31 in the first radial direction (Y). The middle segment 52 abuts resiliently against the nose 311 of the coupler 3 (see FIG. 4) in the first radial direction (Y), and is deformed and is moved frontwardly by a pushing action of the nose 311 when the coupler 3, together with the first stud 41, is moved frontwardly in the first radial direction by an external force resulting from pulling of the sun shield member 63 out of the accommodating space 101 to a fully extended condition.

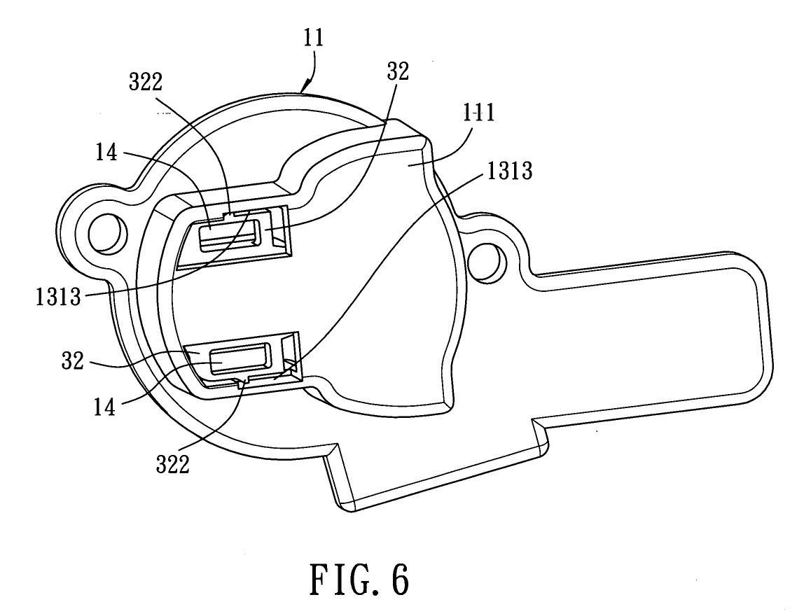

The resilient plate 5 further has curved first and second segments 53, each of which extends between a respective one of the end segments 51 of the resilient plate 5 and the middle segment 52. The first segment 53 cooperates with the middle segment 52 and the second segment 53 to form a wavy structure that has two ridges 53′ corresponding to the first and second segments 53, respectively, and a valley 52′ corresponding to the middle segment 52 (see FIGS. 3 and 6).

The casing 11 has an end wall 111 facing in the axial direction (X), and a surrounding wall 112 extending from a periphery of the end wall 111 in the axial direction (X) and cooperating with the end wall 111 to define the inner space 10. The casing 11 is formed with first and second confining blocks 13 that are opposite to each other in a second radial direction (Z) relative to the axial direction (X) and transverse to the first radial direction (Y). The first and second confining blocks 13 extend in the axial direction (X) from the end wall 111 into the inner space 10, and further extend in the second radial direction (Z) from the surrounding wall 112 into the inner space 10. The casing 11 is further formed with first and second limiting plates 14 that extend respectively from the first and second confining blocks 13 in the second radial direction (Z) toward each other, and that define a gap 140 therebetween. The main body 31 extends through the gap 140 in the axial direction (X) (see FIG. 3), and is limited by the first and second limiting plates 14 against movement in the second radial direction (Z).

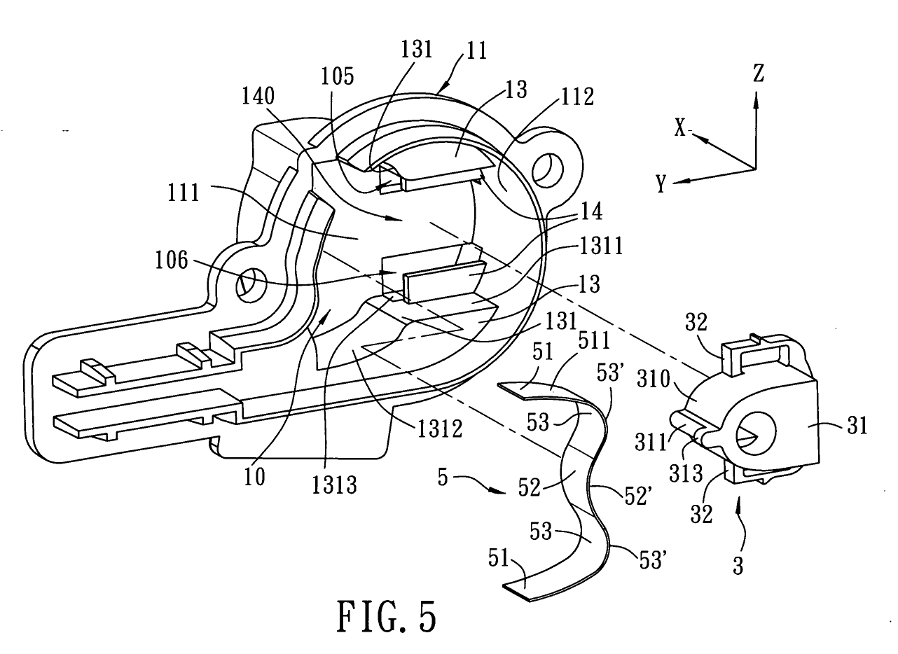

The inner space 10 of the casing 11 has first and second regions 105, 106 (see FIG. 5), each of which is disposed between the end wall 111 of the casing 11 and a respective one of the first and second limiting plates 14. The coupler 3 further includes first and second wings 32 extending from the main body 31 in the second radial direction (Z) into the first and second regions 105, 106 of the inner space 10, respectively (see FIG. 3). The first and second wings 32 are respectively limited by the first and second limiting plates 14 and the main body 31 is limited by the end wall 111 so that the coupler 3 is limited against movement in the axial direction (X).

The first and second confining blocks 13 have end faces 131, respectively (see FIGS. 4 to 6). The end faces 131 face each other in the second radial direction (Z). Each of the end faces (131) of the first and second confining blocks 13 has a flat section 1311 and a curved section 1312 extending curvedly from the flat section 1311. The first and second limiting plates 14 extend from the flat sections 1311 of the end faces 131, respectively. The end segments 51 of the resilient plate 5 are disposed between the curved sections 1311 of the end faces 131 of the first and second confining blocks 13. Each of the end segments 51 of the resilient plate 5 has a curved surface 511 conforming to the curved section 1311 of the end face 131 of a respective one of the first and second confining blocks 13 (see FIGS. 3 and 6).

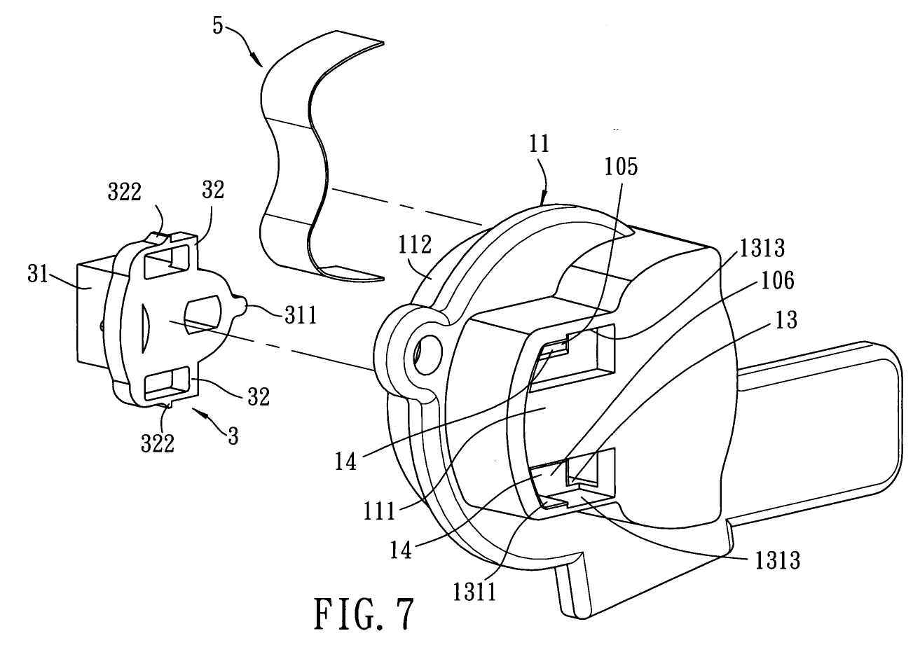

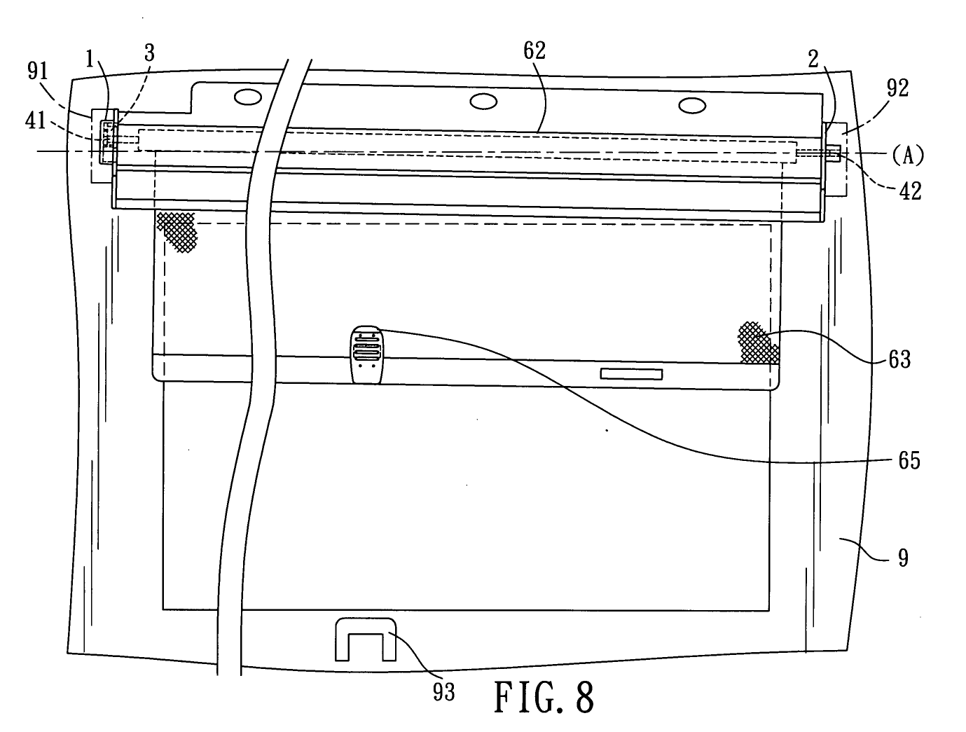

The flat sections 1312 of the end faces 131 of the first and second confining blocks 13 are indented inwardly to form first and second indentations 1313, respectively (see FIGS. 7 and 8). The first and second indentations 1313 are disposed between the end wall 111 and the first limiting plate 14 and between the end wall 111 and the second limiting plate 14, respectively. Each of the first and second wings 32 is formed with a tongue 322 protruding into a respective one of the first and second indentations 1313 for guiding movement of the coupler 3 in the first axial direction (Y).

The resilient plate 5 further has two opposite edges 502 that are opposite to each other in the axial direction (X). The front end 310 of the main body 31 is further formed with a limiting protrusion 313 protruding therefrom in the first radial direction (Y) and connected to one end of the nose 311. The edges 502 of the resilient plate 5 are limited by the end wall 111 of the casing 11 and the limiting protrusion 313, respectively, against movement in the axial direction (X). The end segments 51 of the resilient plate 5 are limited by the surrounding wall 112 and the curved sections 1311 of the end faces 131 of the first and second confining blocks 13 (see FIG. 3) against movement in the first and second radial directions (Y, Z).

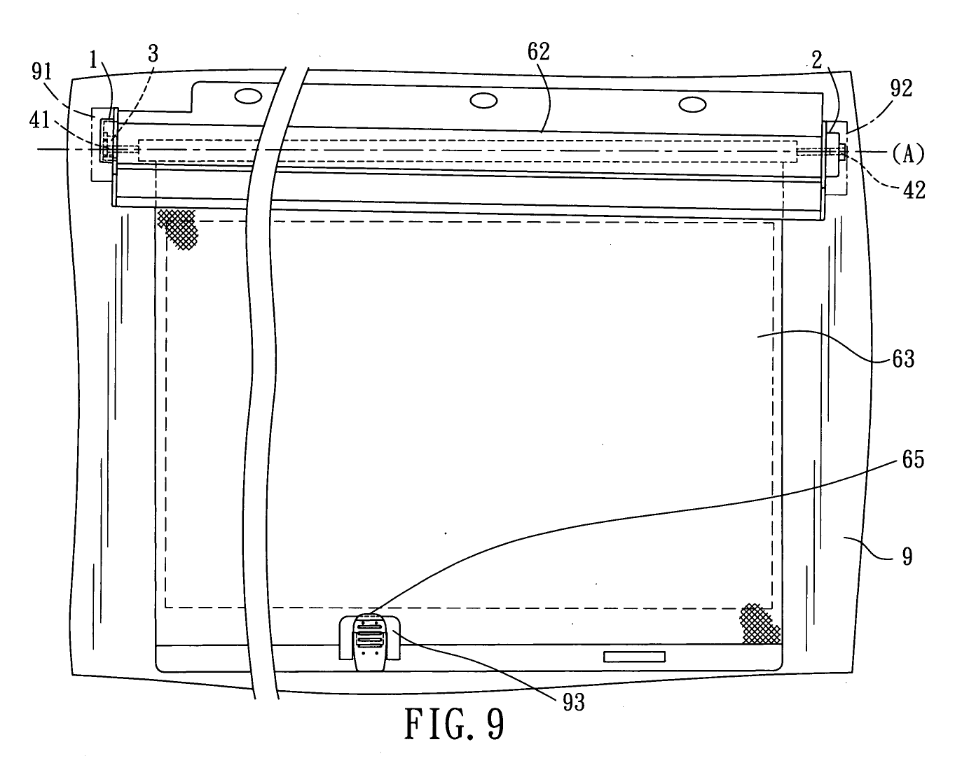

FIGS. 8 and 9 illustrate an application of the sun shield assembly to a car window 9, such as a sunroof. The car window 9 is provided with opposite first and second fixed seats 91, 92 at one side thereof, and a holder 93 at the other side thereof. Referring to FIG. 8, assuming that the first and second fixed seats 91, 92 are not aligned along a desired centerline (A) after being installed to the car window 9, then the difference between the distance between the first stud 41 and the holder 93 is different from the distance between the second stud 42 and the holder 93, and further assuming that the distance between the first stud 41 and the holder 93 is longer than the distance between the second stud 42 and the holder 93, and that the first stud 41 does not lie on the centerline (A), then, referring to FIG. 9, when the sun shield member 63 is entirely pulled out and the engaging means 65 engages the holder 93, the first stud 41 together with the coupler 3 will be pushed by the spool 62 to move frontwardly in the first radial direction (Y) against the urging action of the urging member 5 a distance such that the first stud 41 lies substantially on the centerline (A), thereby preventing the aforesaid non-uniform extension of the sun shield member 63 as encountered in the aforesaid conventional sun shield assembly.

With the inclusion of the coupler 3 and the urging member 5 in the first supporting seat 1 of the sun shield assembly of this invention, the aforesaid drawback associated with the prior art can be eliminated.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A sun shield assembly comprising:
a spool housing provided with first and second supporting seats and defining an accommodating space between said first and second supporting seats;
a spool-supporting unit disposed in said accommodating space and having first and second studs that are opposite to each other in an axial direction and that are coupled to said first and second supporting seats, respectively;
a spool mounted rotatably to said spool-supporting unit; and
a sun shield member wound on said spool and extendable from said spool when unwound from said spool;
wherein said first supporting seat includes a casing defining an inner space, a coupler disposed movably in said inner space and formed with an insert hole, and an urging member mounted in said inner space to urge resiliently said coupler in a first radial direction relative to the axial direction;
wherein said first and second studs extend into said insert hole in said coupler of said first supporting seat and first supporting seat, respectively; and
wherein said coupler of said first supporting seat is movable relative to said casing of said first supporting seat in the first radial direction against the urging action of said urging member.

2. The sun shield assembly of claim 1, wherein said urging member is in the form of a curved resilient plate that has two opposite end segments and a curved middle segment extending between said end segments of said resilient plate, said end segments of said resilient plate abutting against said casing, said coupler including a main body that is formed with said insert hole, that has a front end, and that is formed with a nose protruding from said front end of said main body in the first radial direction, said middle segment abutting resiliently against said nose of said coupler in the first radial direction.

3. The sun shield assembly of claim 2, wherein said resilient plate further has curved first and second segments, each of which extends between a respective one of said end segments of said resilient plate and said middle segment, said first segment cooperating with said middle segment and said second segment to forma wavy structure that has two ridges corresponding to said first and second segments, respectively, and a valley corresponding to said middle segment.

4. The sun shield assembly of claim 3, wherein said casing has an end wall facing in the axial direction, and a surrounding wall extending from a periphery of said end wall in the axial direction and cooperating with said end wall to define said inner space, said casing being formed with first and second confining blocks that are opposite to each other in a second radial direction relative to the axial direction and transverse to the first radial direction, said first and second confining blocks extending in the axial direction from said end wall into said inner space and further extending in the second radial direction from said surrounding wall into said inner space, said casing being further formed with first and second limiting plates that extend respectively from said first and second confining blocks in the second radial direction toward each other, and that define a gap therebetween, said main body extending through said gap in the axial direction and being limited by said first and second limiting plates against movement in the second radial direction.

5. The sun shield assembly of claim 4, wherein said inner space of said casing has first and second regions, each of which is disposed between said end wall of said casing and a respective one of said first and second limiting plates, said coupler further including first and second wings extending from said main body in the second radial direction into said first and second regions of said inner space, respectively, said first and second wings being respectively limited by said first and second limiting plates and said main body being limited by said end wall so that said coupler is limited against movement in the axial direction.

6. The sun shield assembly of claim 5, wherein said first and second confining blocks have end faces, respectively, said end faces facing each other in the second radial direction, each of said end faces of said first and second confining blocks having a flat section and a curved section extending curvedly from said flat section, said first and second limiting plates extending from flat sections of said end faces, respectively, said end segments of said resilient plate being disposed between said curved sections of said end faces of said first and second confining blocks, each of said end segments of said resilient plate having a curved surface conforming to said curved section of said end face of a respective one of said first and second confining blocks.

7. The sun shield assembly of claim 6, wherein said flat sections of said end faces of said first and second confining blocks are indented inwardly to form first and second indentations, respectively, said first and second indentations being disposed between said end wall and said first limiting plate and between said end wall and said second limiting plate, respectively, each of said first and second wings being formed with a tongue protruding into a respective one of said first and second indentations.

8. The sun shield assembly of claim 4, wherein said resilient plate further has two opposite edges that are opposite to each other in the axial direction, said front end of said main body being further formed with a limiting protrusion protruding therefrom in the first radial direction and connected to one end of said nose, said edges of said resilient plate being limited by said end wall of said casing and said limiting protrusion, respectively, against movement in the axial direction.

9. The sun shield assembly of claim 6, wherein said end segments of said resilient plate are limited by said surrounding wall and said curved sections of said end faces of said first and second confining blocks against movement in the first and second radial directions.
